(19) United States
(12) Patent Application Publication
(10) Pub. No.: US 2017/0358805 A1
(43) Pub. Date: Dec. 14, 2017

(54) STRUCTURE OF FUEL CELL

(71) Applicant: Hyundai Motor Company, Seoul (KR)

(72) Inventors: Dae Il YOON, Yongin-si (KR); Yoo Chang YANG, Gunpo-si (KR); Suk Min BAECK, Seongnam-si (KR)

(21) Appl. No.: 15/290,435

(22) Filed: Oct. 11, 2016

(30) Foreign Application Priority Data
Jun. 13, 2016 (KR) 10-2016-0073135

(51) Int. Cl. H01M 8/0273; H01M 8/0258

(52) U.S. Cl. CPC H01M 8/0273; H01M 8/0258

(57) ABSTRACT

A structure of a fuel cell includes a sub-gasket coupled to both sides of a membrane electrode assembly; a plurality of gaskets protruding from a separator to form a flow space between the sub-gasket and the separator and supporting the sub-gasket; and a supporting member coupled to the sub-gasket at a position corresponding to the flow space, the supporting member preventing the sub-gasket from being deformed and being formed in a flat shape.

### CROSS REFERENCE TO RELATED APPLICATION

The present application claims the benefit of priority to Korean Patent Application No. 10-2016-0073135, filed on Jun. 13, 2016 in the Korean Intellectual Property Office, the entirety of which is incorporated herein for all purposes by this reference.

### TECHNICAL FIELD

The present disclosure relates to a structure of a fuel cell, and more particularly, the present disclosure relates to a structure of a fuel cell capable of preventing a sub-gasket of membrane electrode assembly from being deformed by long-term operation.

### BACKGROUND

Generally, a fuel cell is a power generator which converts chemical energy into electrical energy by using the oxidation-reduction reaction of hydrogen and oxygen. The hydrogen is oxidized at a negative electrode (anode) to be separated into hydrogen ions and electrons, and the hydrogen ions migrate to a positive electrode (cathode) through electrolytes. Furthermore, the electrons migrate to the cathode through an electrical circuit. In the reduction reaction, oxygen reacts with the electrons and hydrogen ions to generate water, and this takes place at the cathode.

Since the low voltage of a unit cell of the fuel cell degrades the practicality thereof, several hundreds of unit cells are generally used in a stacked formation. A separator serves to make an electrical connection between the unit cells when the unit cells are stacked and also serves to separate the reaction gas.

The unit cell of a fuel cell stack is composed of the separator, gas diffusion layer (GDL) and membrane electrode assembly (MEA). The membrane electrode assembly at which the chemical reaction takes place is provided between the separators, and two gas diffusion layers are applied to anode/cathode electrode surfaces of both sides of the membrane electrode assembly, respectively. The set of the separators, two gas diffusion layers and the membrane electrode assembly stacked like this are coupled under high pressure when making the fuel cell stack.

FIGS. 1A and 1B are cross sectional views showing a unit cell of a fuel cell according to the prior art. Referring to FIG. 1A, the unit cell of a fuel cell stack is fixed under high pressure in a state such that a sub-gasket 603 of a MEA 600 and a gasket 613 of a separator 610 contact each other, and reaction gas enters through a structure of an inlet and outlet 615 formed between the sub-gasket 603 of the MEA 600 and the separator 610.

Mainly, a thin film formed of Poly ethylene naphthalate (PEN) materials is applied to the sub-gasket 603 of the MEA 600, but in a case that the fuel cell stack is long operated under conditions of high temperature (60˜80° C.) and high humidity and differential pressure between reactive surfaces of the anode and cathode of the unit cell, the sub-gasket 603 of the MEA 600 may be deformed as shown in FIG. 1B.

The deformation of the sub-gasket 603 of the MEA 600 may make flow space of the reaction gas narrow at unspecified cells and reduce water discharge performance of the unit cell and distribution performance of the reaction gas, thereby deteriorating the performance and efficiency of the fuel cell.

To further describe for understanding, FIG. 2 is a drawing showing a separator per unit cell of the fuel cell according to the prior art, and FIGS. 3A and 3B are cross sectional views along A-A′ line in FIG. 2.

FIG. 3A shows a cross sectional view of an inlet and outlet portion of reaction gas per unit cell in a fuel cell stack according to the prior art, and the sub-gasket 603 of MEA 600 maintains a flat state in a normal case. However, in a case that the fuel cell is long operated under conditions of high temperature and high humidity, the deformation takes place at the sub-gasket 603 of MEA 600 as shown in FIG. 3B.

The foregoing is intended merely to aid in the understanding of the background of the present disclosure, and is not intended to mean that the present disclosure falls within the purview of the related art that is already known to those skilled in the art.

### SUMMARY

The present disclosure is intended to propose a structure of a fuel cell capable of preventing a sub-gasket from being deformed due to a long operation of a fuel cell stack by adding a separate supporting member to the sub-gasket of a membrane electrode assembly.

A structure of a fuel cell according to the present disclosure in order to achieve the above described object may include a sub-gasket coupled to both sides of a membrane electrode assembly; a plurality of gaskets protruding from a separator to form a flow space between the sub-gasket and the separator and supporting the sub-gasket; and a supporting member coupled to the sub-gasket at a position corresponding to the flow space, the supporting member preventing the sub-gasket from being deformed and being formed in a flat shape.

A plurality of the supporting members may be provided, and the plurality of the supporting members may extend from between the plurality of gaskets and the sub-gasket to the flow space.

The supporting member may include a protrusion formed to protrude to cover a side portion of the gasket.

The separator may include a flow hole allowing the reaction gas to flow into or out from the flow space; and the supporting member may be coupled to the surface of the sub-gasket facing the flow hole.

The supporting member may be formed of a mesh-type material.

The supporting member may be formed of stainless steel.

The supporting member may be coupled to the sub-gasket before being layered to a fuel cell stack.

The supporting member may be spot-welded to the sub-gasket.

According to the structure of a fuel cell configured as described above, it is possible to prevent a sub-gasket of a membrane electrode assembly from being deformed due to long operation of a fuel cell stack.

Since the reduction of water discharge performance of the unit cell of the fuel cell and distribution performance of reaction gas is hampered by preventing the deformation of the sub-gasket, it is possible to prevent deterioration of the performance and efficiency of the fuel cell.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1A and 1B are cross sectional views showing a unit cell of a fuel cell according to the prior art.

FIG. 2 is a drawing showing a separator per unit cell of fuel cell according to the prior art.

FIGS. 3A and 3B are cross sectional views along A-A′ line in FIG. 2.

FIG. 4 is a cross sectional view showing a unit cell of a fuel cell in a structure of a fuel cell according to an exemplary embodiment in the present disclosure.

FIG. 5 is a drawing showing a structure of a fuel cell according to an exemplary embodiment in the present disclosure.

FIGS. 6A and 6B are cross sectional views along B-B′ line in FIG. 5.

FIGS. 7A and 7B are drawings showing a supporting member according to an exemplary embodiment in the present disclosure.

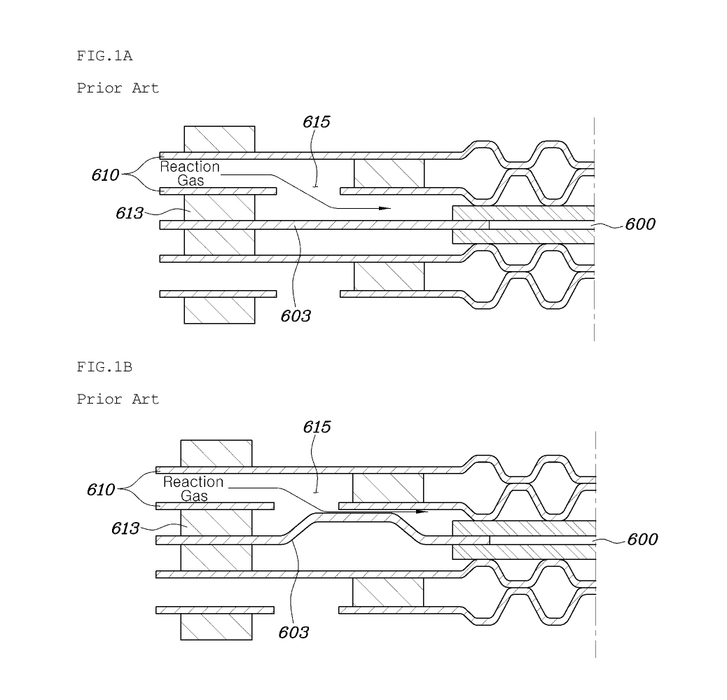

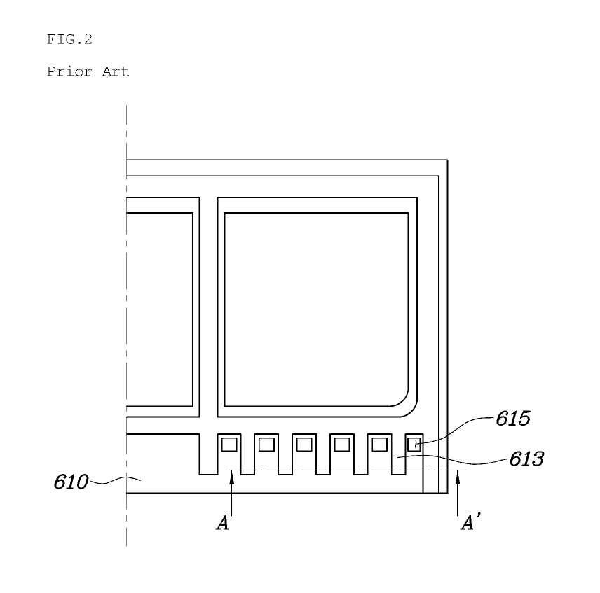

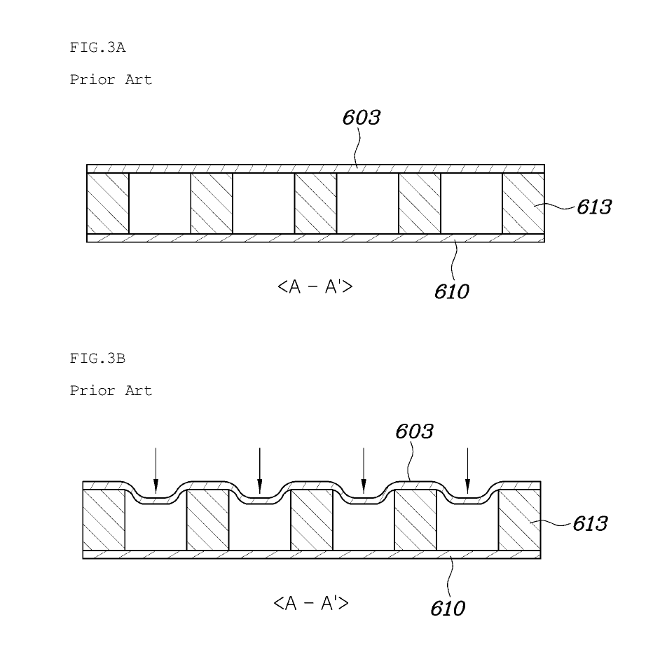

### DETAILED DESCRIPTION OF THE EMBODIMENTS

Hereinafter, a structure of a fuel cell according to an exemplary embodiment in the present disclosure will be described with reference to the accompanying drawings.

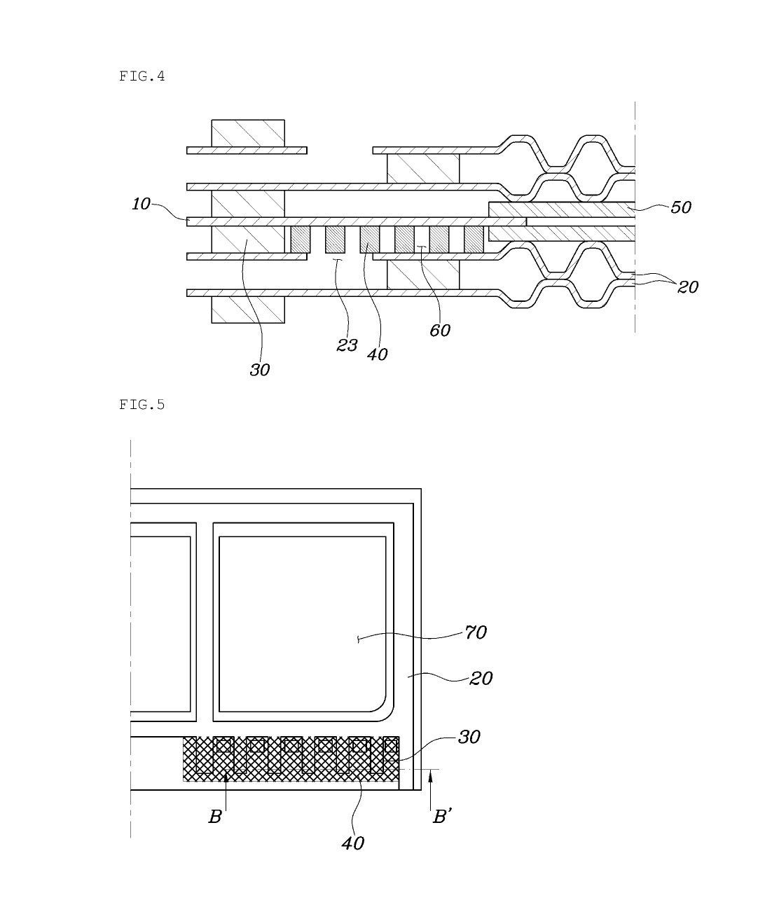

FIG. 4 is a cross sectional view showing a unit cell of a fuel cell in a structure of a fuel cell according to an exemplary embodiment in the present disclosure. FIG. 5 is a drawing showing a structure of a fuel cell according to an exemplary embodiment. Referring to FIGS. 4 and 5, the structure of a fuel cell may include a sub-gasket 10 coupled to both sides of a membrane electrode assembly 50; a plurality of gaskets 30 protruding from a separator 20 to form a flow space 60 between the sub-gasket 10 and the separator 20 and supporting the sub-gasket 10; and a supporting member coupled to the sub-gasket 10 at a position corresponding to the flow space 60 for preventing the sub-gasket 10 from being deformed and formed in a flat shape.

Unit cells of a fuel cell stack may be configured so that the membrane electrode assembly (MEA) 50 is provided between each of the plurality of separators 20, and the sub-gasket 10 is provided at both sides of the membrane electrode assembly 50 such that the membrane electrode assembly 50 can be fixedly supported between the separators 20.

For example, the membrane electrode assembly 50 shown in FIG. 4 may be configured to be surrounded by a gas diffusion layer (GDL), and the gas diffusion layer (GDL) may be provided to be in contact with the separator 20.

If the fuel cell stack is operated for a long time, the reaction gas flows into the flow space 60 may apply heat and pressure to the sub-gasket 10. Due to this, the sub-gasket 10 may be deformed. The present technology is able to prevent the sub-gasket 10 from being deformed by coupling the supporting member 40 to the sub-gasket 10. In particular, this prevents deformation to the position corresponding to the flow space 60.

The present disclosure may feature that a plurality of the supporting members 40 are provided, and the plurality of the supporting members extend from between a plurality of gaskets 30 and the sub-gasket 10 to the flow space 60.

That is, the supporting member 40 may be coupled to the sub-gasket 10, but provided between the gasket 30 and the sub-gasket 10 in order to increase coupling force between the sub-gaskets 10.

In this configuration, an exemplary embodiment in the present disclosure may feature that a flow hole 23 is formed at the separator 20 in order for the reaction gas to flow into or out the flow space 60 and the supporting member 40 is coupled to the surface of the sub-gasket 10 facing the flow hole 23.

Generally, a manifold hole 70, which the reaction gas flows into or flows out from, is formed at the both sides of the separator 20, and the flow hole 23 is formed at one side of the separator 20 in order to induce the reaction gas, which flows into from the manifold hole 70, to flow into the membrane electrode assembly (MEA) through the flow space 60 so as to be reacted, and the flow hole 23 is formed at the other side of the separator 20 in order for the reaction gas to flow out from the flow space 60 into the manifold hole 70.

In this configuration, the supporting member 40 is coupled to the surface of the sub-gasket 10 facing the flow hole 23. This configuration is that the supporting member 40 is coupled to the surface of the sub-gasket 10 directly contacted with the reaction gas, thereby effectively preventing the deformation of the sub-gasket 10.

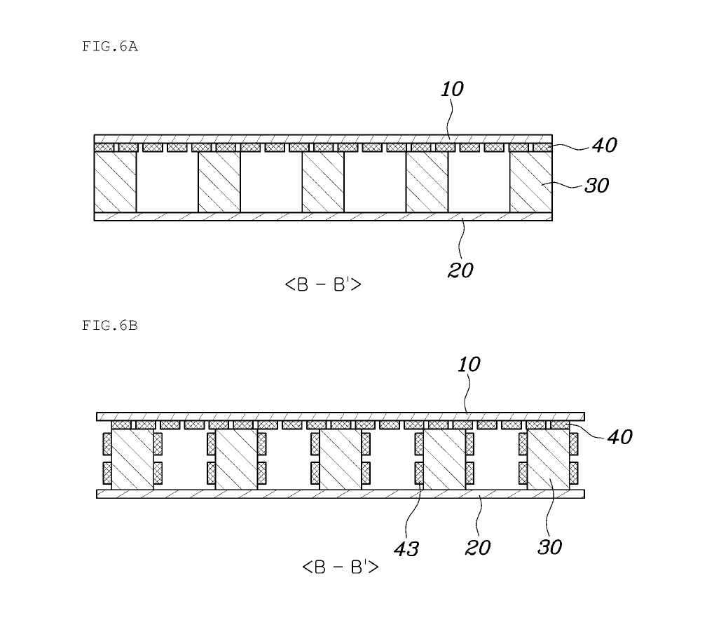

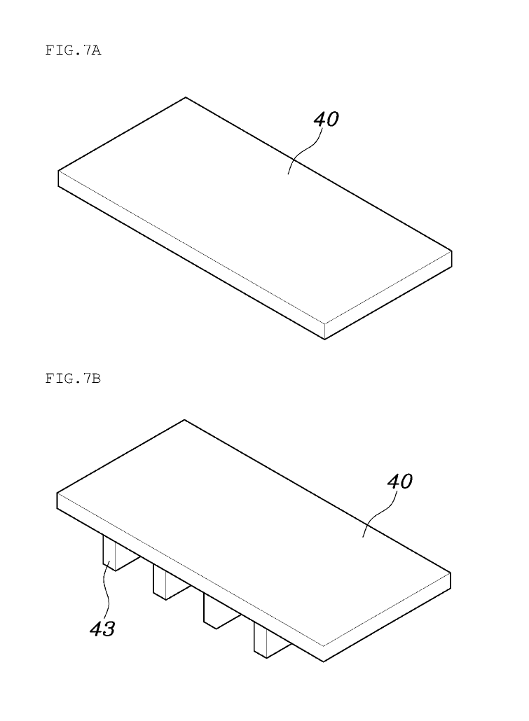

FIGS. 6A and 6B are cross sectional views along B-B′ line in FIG. 5. FIGS. 7A and 7B are drawings showing a supporting member according to an exemplary embodiment in the present disclosure. As shown in FIGS. 6A and 7A, the supporting member 40 according to an exemplary embodiment is provided between the sub-gasket 10 and the gasket 30 with a flat shape, thereby preventing the deformation of the sub-gasket 10.

In this configuration, if the supporting member 40 is applied as a flat shape, the cost and time for manufacturing the supporting member 40 can be reduced to a minimal level.

On the other hand, the supporting member 40 according to another exemplary embodiment in the present disclosure, as shown in FIGS. 6B and 7B, may include a protrusion 43 formed to be protruded in order to cover a side portion of the gasket 30.

That is, the supporting member 40 may be stably coupled to the sub-gasket 10 via the protrusion 43. Due to this, the supporting member 40 may more effectively prevent the sub-gasket 10 from being deformed.

Furthermore, the supporting member 40 may be formed of a mesh-type material or stainless steel.

For example, the supporting member 40 may be formed of stainless steel as an alloy material having a low heat conductivity, excellent mechanical strength and ductility in order to play a role in preventing the deformation of the sub-gasket 10. The supporting member 40 may be formed of a mesh-type material having 40˜60 μm thickness such that it is possible to minimize the thickness of the unit cell and to form the strength capable of preventing the deformation of the sub-gasket 10.

In this configuration, the thickness of the supporting member 40 is proposed only for explanation and may be variably applied depending on designer, and therefore, should not be limited to a specific value.

The supporting member 40 may be coupled to the sub-gasket 10 before being layered to the fuel cell stack. Also, the supporting member 40 may be spot-welded to the sub-gasket 10.

According to the structure of a fuel cell configured as described above, it is possible to prevent a sub-gasket of a membrane electrode assembly from being deformed due to long-term operation of a fuel cell stack.

Since the reduction of water discharge performance of the unit cell of the fuel cell and distribution performance of reaction gas is hampered by preventing the deformation of the sub-gasket, it is possible to prevent deterioration of the performance and efficiency of the fuel cell.

Although exemplary embodiments in the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A structure of a fuel cell comprising:
a sub-gasket coupled to both sides of a membrane electrode assembly;
a plurality of gaskets protruding from a separator to form a flow space between the sub-gasket and the separator and supporting the sub-gasket; and
a supporting member coupled to the sub-gasket at a position corresponding to the flow space, the supporting member preventing the sub-gasket from being deformed and being formed in a flat shape.

2. The structure of a fuel cell of claim 1, wherein a plurality of the supporting members are provided, and the plurality of the supporting members extend from between the plurality of gaskets and the sub-gasket to the flow space.

3. The structure of a fuel cell of claim 1, wherein the supporting member comprises a protrusion formed to protrude to cover a side portion of the gasket.

4. The structure of a fuel cell of claim 1, wherein the separator includes a flow hole allowing the reaction gas to flow into or out from the flow space; and
the supporting member is coupled to the surface of the sub-gasket facing the flow hole.

5. The structure of a fuel cell of claim 1, wherein the supporting member is formed of a mesh-type material.

6. The structure of a fuel cell of claim 1, wherein the supporting member is formed of stainless steel.

7. The structure of a fuel cell of claim 1, wherein the supporting member is coupled to the sub-gasket before being layered to a fuel cell stack.

8. The structure of a fuel cell of claim 1, wherein the supporting member is spot-welded to the sub-gasket.
